(19) United States
(12) Patent Application Publication
(10) Pub. No.: US 2010/0115723 A1
(43) Pub. Date: May 13, 2010

(54) COMPLETELY PORTABLE LIGHTWEIGHT HANDHELD WINDOW CLEANING KET

(76) Inventors: CORDELLIA MAPALO, WOODLAND, CA (US); DON CAROTHERS, WOODLAND, CA (US)

Correspondence Address: CORDELLIA MAPALO, 232 WEBER STREET, WOODLAND, CA, 95695, US

(21) Appl. No.: 12/267,616

(22) Filed: Nov. 10, 2008

(51) Int. Cl. B05B 15/00

(52) U.S. Cl. 15/121; 239/289

(57) ABSTRACT

A Completely Portable Lightweight Handheld Window Cleaning Kit that can be store easily in any cleaning cart, in any cabinet, on any boat, in any travel trailer in any vehicle or any convenient location for use of any glass window at anytime. This windshield/window cleaning kit cleans the any windows any time. This Completely Portable Lightweight Handheld Window Cleaning Kit is made of a tooled molded plastic that can be any size or shape, or any color. The Window Cleaning Kit has workable cleaning tools housed within its housing unit. Encased within the housing unit will be a spray bottle for holding the cleaning solution, a squeegee for wipe off the water sprayed on the window and a towel to wipe off excess fluid from the windshield/windows. This Completely Portable Lightweight Handheld Window Cleaning Kit will be an improvement over other glass window/windshield cleaning devices, as this Completely Portable Lightweight Handheld Window Cleaning Kit will be accessible at all times to the driver by being of a size that it can be stored on the dashboard, on the console or in glove compartment and handy for Janitorial Supply companies or Everyday cleaning in household by being of a size that can be store anywhere and contain every thing needed to clean in one central housing unit.

### FIELD OF INVENTION

The present invention relates to the field of A Completely Portable Lightweight Handheld Window Cleaning Kit in general, and particular to a conveniently located, readily accessible, complete washing kit all combined into this Completely Portable Lightweight Handheld Window Cleaning Kit for use on any windows or glass surfaces.

This Completely Portable Lightweight Handheld Window Cleaning Kit can be stored under the sink, in a small cabinet, in a boat, in a janitorial cart, can lay on the dash board, center console, the window side pocket or glove company anyone is one small complete package. The spray nozzle, cap, squeegee and towel are all that is needed to completely clean any window in any situation.

This Completely Portable Lightweight Handheld Window Cleaning Kit is in itself a complete window cleaning kit, each kit includes cleaning solution, a squeegee to remove liquids and a towel to absorb any excess fluids left on any window or glass surface or any automobile windows in case of fog, rain, condensation or good old fashion dirt and grim.

### BACKGROUND OF INVENTION

Self contained window/windshield cleaning or washing devices are known and are described in U.S. Pat. No. 5,299,876 (Singarella), U.S. Pat. No. 2,886,839 (Leopold) and U.S. Patent Number 20030037390 (Leblanc).

These present inventions relate to washing/cleaning tools combined to make cleaning devices and more particularly to portable, self contained units. These inventions claim to have workable tools capable of affording the operator the use of a cleaning fluid sprayer, a sponge, a squeegee, a scraper and/or a brush. Most of these inventions provide compressible container of a novel type that effectively serve as the handle for the cleaning tools mounting thereon.

While these devices fulfill their particular objective, the above patents do not disclose a new portable, self contained, convenient, lightweight combination of window cleaning tools. These inventions all encompass elongated shafts with head portion, elongated resiliently flexible squeegee blades, compressible sponge members and a resiliently compressible scrubbing pad that are not of easy access to a user for immediate use.

In this respect, the Completely Portable Lightweight Handheld Window Cleaning Kit according to the present invention is substantially different from the conventional concepts and designs of any prior art, and in so doing provides a new art apparatus developed to clean the interior windshield/window of a automobile or any vehicle and the portable to all

Glass and windows anywhere and adds in particular the convenient location and easy access of the interior windshield/window cleaning kit to the vehicles operator as the invention is stored on the dash-board, console, and side window pocket or glove compartment of the automobile or vehicle. The receptacle or housing unit of my present invention is made of a lightweight plastic and will not rust or scratch the surface of the vehicle windshield or any other glass or house windows. The receptacle or housing unit of this new Completely Portable Lightweight Handheld Window Cleaning Kit can come in many different colors or with in a cloth casing.

### SUMMARY OF THE INVENTION

It is the intention of this invention to provide an Completely Portable Lightweight Handheld Window Cleaning Kit with self contained tools which will improve the convenience and easy access to a cleaning device which will clean the any windows, any glass, the interior windshield and any other car windows. It is the intention of this invention to provide easy access and easy storability of this Completely Portable Lightweight Handheld Window Cleaning Kit within the reach of the operator of the vehicle and any other place conveniently location to store cleaning supplies. This invention is designed to be conveniently stored in janitorial carts, in kitchen cabinets, bathroom cabinets, boats, travel trailers or to sit on the dash-board, console, in the window side pocket or the glove compartment of a vehicle.

This invention is a three component window/windshield cleaning kit that includes a spray bottle for spraying window cleaner on any glass, windshield or windows of a house, boat, vehicle or travel trailer, a soft rubber cleaning blade for swiping the windshield, glass or windows to remove the window cleaner, grim or dirt and an absorbent towel to wipe off any access cleaning fluid left on the glass, windows or windshield of a vehicle.

This Completely Portable Lightweight Handheld Window Cleaning Kit invention according to the present inventions is substantially different from the conventional concepts and designs of any prior art. This invention provides a new use for a spray bottle, a squeegee and a towel which is all combined into a new art apparatus and housed in a receptacle or housing unit in all colors and shapes. This invention was developed to be a Completely Portable Lightweight Handheld Window Cleaning Kit for easy cleaning of all glass, windows and windshields, with particular attention to its new convenient of a complete cleaning tool and convenient storage locations and easy access to the interior windshield/window in a vehicle for any operator or any passenger in the vehicle to use. This invention made of a plastic, and being waterproof is an excellent tool for boats and travel trailers and fits in any console, side window pocket or glove compartment.

### BRIEF DESCRIPTION OF THE DRAWINGS

An embodiment of the present invention will now be disclosed, by way of, illustrations in reference to the following drawings in which:

FIG. 1 is a perspective view of an embodiment of a Completely Portable Lightweight Handheld Window Cleaning Kit from the side according to the present invention when in use.

FIG. 2 is a perspective view of an embodiment of the Completely Portable Lightweight Handheld Window Cleaning Kit from the underside according to the present invention when in use.

FIG. 3 is an exploded perspective view of an embodiment of the Completely Portable Lightweight Handheld Window Cleaning Kit according to the present invention assembled when in use.

FIG. 4 is an exploded perspective view of an embodiment of the towel tube receptacle at the rear of the Completely Portable Lightweight Handheld Window Cleaning Kit with the towel inserted to show how it will attach to the rear of the towel tube receptacle of the invention.

FIG. 5 is an exploded perspective view of an embodiment of the receptacle or housing unit of the Completely Portable Lightweight Handheld Window Cleaning Kit without the cleaning tools attached to the invention.

FIG. 6 is a perspective view of an embodiment of the receptacle or housing unit of the Completely Portable Lightweight Handheld Window Cleaning Kit with the top portion showing the threads for the attachment of the spray nozzle pump, pump tube and cap of the invention.

FIG. 7 is a perspective view of an embodiment of the receptacle or housing unit of the Completely Portable Lightweight Handheld Window Cleaning Kit showing the openings for squeegee and the towel tube receptacle. FIG. 7 is additionally displaying an exploded embodiment of the base and squeegee which will be inserted into the middle opening in the embodiment of the receptacle or housing unit. The base, which can be made of plastic, styrofoam, wood or a resilient material, and a squeegee, strip made of resilient material, will be assembled together with glue, stitched or made as a whole piece of elongated resilient material that will whole the squeegee for this invention.

FIG. 8 is a view similar to FIG. 7, presenting the embodiment of the Completely Portable Lightweight Handheld Window Cleaning with an exploded drawing of the towel tube receptacle when inserted into the drawing next to the opening in the receptacle or housing unit in which the towel tube receptacle will be placed into the invention.

FIG. 9 is a view similar to FIG. 8, presenting the embodiment of the Completely Portable Lightweight Handheld Window Cleaning Kit with the receptacle or housing unit assembled displaying the towel tube receptacle inserted into the housing unit attached with glue or stitching closing the rear of the embodiment. An exploded view of the towel showing the plastic or metal ring assembly is displayed next to the towel tube receptacle.

FIG. 10 is the Portable Lightweight Handheld Window Cleaning Kit additionally displaying additional variations of the end of the Cleaning kit that could possible be attached to the towel opening for other types on paper products to be used with this invention.

### DETAILED DESCRIPTION OF PREFERRED EMBODIMENTS OF THE INVENTION

With reference to the drawings in general, the drawings illustrate Completely Portable Lightweight Handheld Window Cleaning Kit and more precisely a portable, lightweight, self-contained, easy accessible receptacle or housing unit primarily adapted for the cleaning of the interior windshield of a vehicle, boat windshield, all windows and any glass. These drawings will describe the current embodiment, it will be understood that I do not intend to limit the cleaning kit to these embodiments. This embodiment will come in various sizes, and colors. I will cover and describe differences, alternatives and modifications as may be included within the spirit and scope of these embodiments.

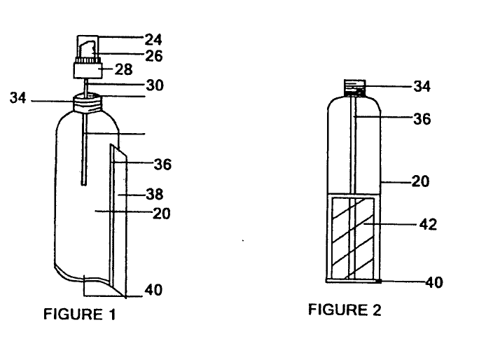

FIG. 1 is an illustration showing the perspective view from the front side and an exploded view of the embodiment's nozzle pump 26 and cap 24 of the presented completely portable lightweight window cleaning kit 22. The embodiments of the basic receptacle or housing unit 20 will be molded of various hard plastics in different widths and lengths of plastic. This embodiment 20 will consist of many different lengths and widths of plastics. The embodiment of the body of the receptacle or housing 20 units is made to hold the spray bottle 28, 26, 24, 30, a squeegee 38, a base 36 or a combined squeegee/base 38, 36 and a towel tube receptacle 42.

The top portion 34 of the receptacle or housing unit 20 of the embodiment will be used for attaching the cap 24 of the spray bottle 28, the pump nozzle 26, and the stem of the spray bottle 30. The top portion 34 of the receptacle or housing unit 20 will also contain threads 34 to attach the spray bottle neck 28 of the receptacle or housing unit 20. The top opening 34 of the receptacle or housing unit 20 will be used for connecting the nozzle 26 of the spray bottle, tube 30 within the spray bottle, and the base of the spray bottle 28. The middle opening 36 of the receptacle or housing unit 20 will be used to conceal the base 36 or handgrip of the squeegee 38 and elongated flexible squeegee 38 blades or a unit combination of both base and squeegee 36, 38. The bottom opening 40 of the receptacle or housing unit 20 will be used for concealing the towel tube receptacle 42 which is presented in this embodiment as a generally cylindrical inter configuration.

FIG. 2 illustrates the embodiment of the completely portable lightweight window cleaning kits 22 receptacle or housing unit 20. It is showing the treads 34 molded into the receptacle or housing unit 20, the molded middle opening 36 which will hold the squeegee. This Figure show the inserted towel tube receptacle 42 inserted into the molded bottom end 40 on the receptacle or housing unit 20.

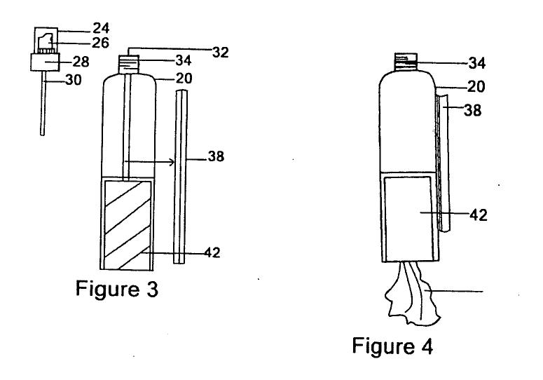

FIG. 3 illustrates a perspective view of the receptacle or housing unit 20 of the embodiment of the completely portable lightweight window cleaning kit 22. The embodiment shows the exploded view of the stem of spray nozzle 30, the neck of spray bottle 28, the nozzle of spray bottle 26, and the cap of the spray bottle 24. This figure start at the top opening the housing unit 32, indicating the threads on housing unit 34, the molded receptacle or housing unit 20, the middle opening of housing unit 38, and the towel tube receptacle 42 for insertion into the bottom opening of the housing unit 40. This receptacle or housing unit 20 can range in size from approximately 4-18 inches in length and ½-1½ inches is width. This receptacle or housing unit 20 can be made out of any material to shape the shape can be held and formed into this molded unit mainly any types of plastic or cement.

FIG. 4 illustrates the perspective side view of the completely portable lightweight window cleaning kits 22 receptacle or housing unit 20 of the embodiment with the top opening 32 threads exposed to show the threads 34 of the housing unit 20 assembled. The top opening portion 32 is generally circular in configuration; however, could be squared or any other shape. This figure is showing the middle opening 36 of the housing unit with the squeegee 38 attached and in place. The towel tube receptacle 42 is shown in place with the towel 44 in place to show how the towel will be inserted into the completely portable lightweight window cleaning kit 22.

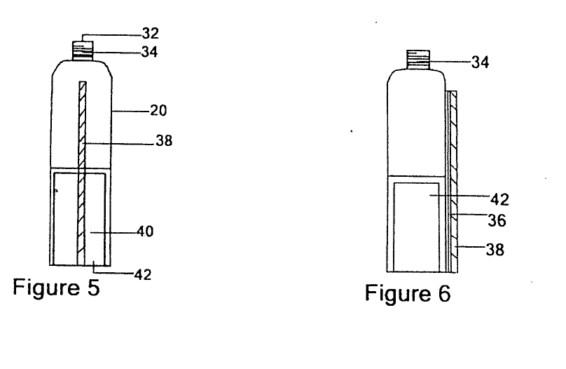

FIG. 5 illustrates a perspective view of the receptacle or housing unit 20 of completely portable lightweight window cleaning kit 22. Again this embodiment shows the top portion 32 and receptacle or housing unit 20 has been reversed to show the outer side of the receptacle or housing unit 20 with the top opening 32, the middle opening with squeegee attached 38 and rear opening 40 with the towel tube receptacle 42 inserted into the housing unit.

FIG. 6 illustrates a perspective view an embodiment similar to FIG. 5 displaying the base/squeegee 36, 38 inserted into the receptacle or housing unit 20 of the embodiment. This base/squeegee 36, 38 will have a generally square or rectangle design for grasping with the hand of the user. In the displayed embodiment, the gripping portion of the base 36 has a generally circle configuration and generally has a length greater than the width. The base 36 of the base/squeegee 36, 38 can be approximately 4-8 inches in length and ½-2 inches in width. This base 36 can be constructed of rubber, metal, wood, Styrofoam or plastic. This combination base/squeegee 36, 38 can be constructed of rubber or a resilient material or any other material known to one skilled in the art of manufacturing squeegees. It is hereby referenced that the squeegee 48 and base 46 can be bonded as one or configured as combined base and blade made out of the reference material above. This base/squeegee 36, 38 design serves as a handle for manipulating the squeegee 38 while the relatively flexible resilient blade will economically provide for the removal of the excess cleaning solution from the windows/windshield. FIG. 6 illustrates the approximate placement of the towel tube receptacle embodiment.

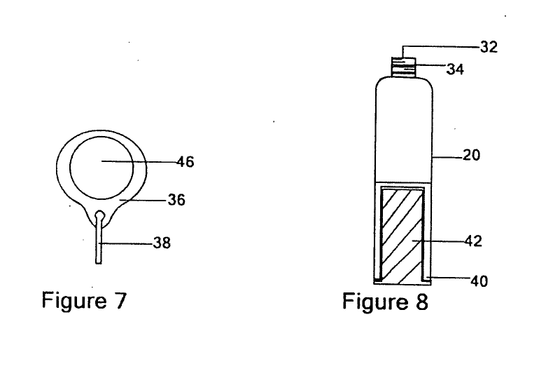

FIG. 7 illustrates a perspective sliced view and the completely portable lightweight window cleaning kit 22 embodiments. This view shows the interior of the housing unit 46, and the molded middle opening 36 of the housing with the squeegee 38 attached. This view represents the space that the towel will has to reside within the receptacle or housing unit. This bottom opening 40 will be used for concealing the towel tube receptacle 42 which has a generally cylindrical outer configuration.

FIG. 8 illustrates perspective view an embodiment similar to FIG. 6. FIG. 8 is displaying the towel tube receptacle 42 and the bottom opening of housing unit 40. The towel tube receptacle 42 placed into the bottom opening 40 within the receptacle or housing unit 20 of the completely portable lightweight window cleaning kit 22. This illustrates also again, shows the top opening of the housing unit 32 and the threads on the housing unit 34.

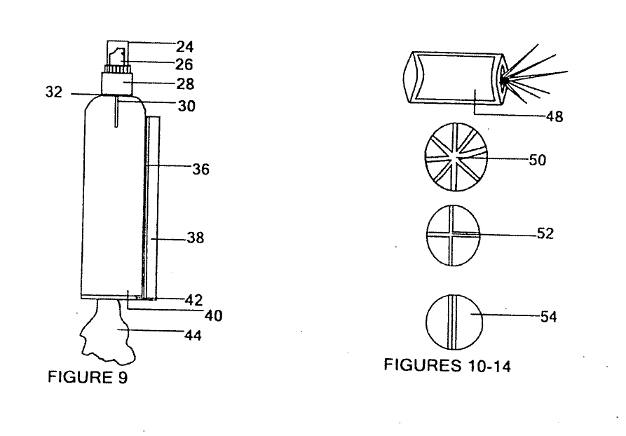

FIG. 9 illustrates a perspective of a completely portable lightweight window cleaning kit 22. This view gives a complete picture of the invention 20, starting with the cap of spray bottle 24, nozzle of spray bottle 26, neck of spray bottle 28, stem of spray bottle 30, top opening of housing unit 32, middle opening of housing unit 36, squeegee 38, bottom opening of housing unit 40, towel tube receptacle 42, and towel 44. These spray bottles can range in sizes, shapes or colors and be manufactured of any material known to one skilled in the art of spray bottle manufacturing.

FIG. 10-14 illustrates a perspective assortment of end caps that can be attached to the completely portable lightweight window cleaning kit 22. These different ends 48, 50, 52 and 54 can be attached to the housing unit bottom opening of the housing unit.

The embodiments of the invention in which an exclusive privileges or property is claimed are defined as below:

1. A Completely Portable Lightweight Handheld Window Cleaning Kit comprising of: a) a housing unit having a body portion receptacle made of a hard plastic; b) a integral spray bottle nozzle and cap inserted on the top portion of said body portion of said housing; c) a handgrip or base tooled to insert a squeegee blade in the middle of said housing;
d) a integral towel tube receptacle inserted in the bottom portion of said body portion of said housing; e) a towel secured to a ring assembly thereof for inserting within the receptacle of said housing; f) said housing made of lightweight plastic allowing cooperative means of move ability and portability of said housing; g) of a size and shape that can be carried with ease or sits on a dashboard or car stored in console or cleaning cart conveniently within reach for ready access.

2. A Completely Portable Lightweight Handheld Window Cleaning Kit as recited in claim 1 wherein: said housing is tooled out of a single piece of tooled molded plastic and which tooled plastic is between 4-10 inches in length and is ranging in width of ½ to 1½ inches in diameter. Tooled molded plastic body portion will be covered with a label made of plastics, fabrics or any other covering that are flexible and water proof. The tooled molded plastic housing unit will be designed with three openings; this will be constructed during the tooling of said plastic molded housing unit; a) the top opening will be treaded at the top for the insertion of the spray bottle nozzle and cap; b) The side molded opening will act as the base of the squeegee, for the insertion of the black squeegee blade; c) the bottom opening with be the towel tube receptacle and be hollow for the housing of the towel; d) The towel will be for the absorption of any excess fluids on the glass.

3. A Completely Portable Lightweight Handheld Window Cleaning Kit as recited in claim 2 wherein: said housing will be in many colors and sizes; said top opening will be treaded and attached to a spray nozzle and cap; a) this spray nozzle will be of a standard size and of any color; b) the cap of the spray nozzle will be of any color and prevents fluid from escaping from said nozzle; c) said housing will contain middle opening ranging in length from 4-10 inches, this middle opening of said housing unit will contain a strip of black or any color squeegee or wiper blade of black rubber to remove said water sprayed by said nozzle off said window; d) said housing will contain a ½ inch to 1 and ½ in hollow tube, this tube will be the receptacle for the cloth or micro fiber towel to be housed in said housing unit; e) this towel or micro fiber cloth will be of any shape, color or size and will be to absorb any fluid left on the window after using the squeegee on the glass;

4. A Completely Portable Lightweight Handheld Window Cleaning Kit as recited in claim 3 wherein: said housing can range in various sizes; said housing should not be of a size that would block the view of a driver while sitting on the dash board of the vehicle or should not be of a size that can't be handle comfortable with a human hand.

5. The Completely Portable Lightweight Handheld Window Cleaning Kit complete portable lightweight hand held complete portable window cleaning kit as recited in claim 1 wherein: said housing unit made up of with three constructed openings; a front/top opening for the insertion of the spray bottle nozzle and cap; a) the spray bottles section will range from 1 to 8 ounce of fluid, made of plastic or a light weight metal; said spray bottle nozzle will then be inserted and secured into said top threaded opening of said housing unit; said spray bottle will have a cap, pump nozzle and tube, neck with threads.

6. A Completely Portable Lightweight Handheld Window Cleaning Kit as recited in claim 5 wherein: said spray bottle cap can be opened to expose said pump nozzle which will apply the liquid inside the spray bottle to the windshield or window; said spray cap will then be closed in some fashion that will cover the actual said cap and pump nozzle of said spray bottle; said closure will be either an extra piece of material attached with a snap, hook or string on said housing.

7. A Completely Portable Lightweight Handheld Window Cleaning Kit as recited in claim 1 wherein: said housing made with three constructed openings; a middle opening for the insertion of a squeegee or wiper blade; said base can range is various widths, thickness and lengths; said base can be manufactured of plastic, rubber, Styrofoam, metal or anything suitable for this design; said squeegee having an elongated dimension and a relatively narrow transverse dimension cleaning blade which attaches to said base.

8. A Completely Portable Lightweight Handheld Window Cleaning Kit as recited in claim 7 wherein: said base and
squeegee or wiper blade can range in length and depth; said base squeegee or wiper blade should be no longer than said middle opening;
said squeegee or wiper blade can be made of any material know to one skilled in the art of manufacturing squeegees or blades of a Silone nature; said base and squeegee when combined in said receptacle will be used as the handgrip and run down said middle opening of said receptacle; said base and squeegee are then secured into said receptacle by bringing the two sides of the molded housing unit together at said middle opening; said two sides are molded to form track for the insertion of squeegee or wiper blade material. The base is attached to the squeegee in a manner that the operator will be able to drag said squeegee across the windshield/window of the vehicle or window to remove dirt and debris off the glass.

9. A Completely Portable Lightweight Handheld Window Cleaning Kit as recited in claim 1 wherein: said housing made up of three constructed openings; a bottom or rear opening for the insertion of the towel tube receptacle into the said housing;
said towel tube receptacle will be tooled of out of plastic, PVC, metal or paper; said towel tube receptacle will be used for easy insertion or connection of the towel to the said housing.

10. A Completely Portable Lightweight Handheld Window Cleaning Kit as recited in claim 1 wherein: said housing is tooled completely out of plastic or a similar material. In any size, shape or color.

11. A Completely Portable Lightweight Handheld Window Cleaning Kit as recited in claim 1 wherein: said housing unit is equipped with a detachable absorbing towel to wipe off excess fluid from the windshield/windows; said towel will come with a plastic or metal ring assembly or tube smaller in diameter than that of the said towel tube receptacle for easy insertion and/or connecting to the said towel tube receptacle; said absorbing towel made of any fabric will come in many shapes, colors and sizes; said towel can carry words, signs, logos or pictures.

12. A Completely Portable Lightweight Handheld Window Cleaning kit as recited in claim 1: a) said housing made of lightweight fabric or plastic allowing cooperative means of move ability and portability within the vehicle transporting said housing; b) of a size and shape that sits on a dashboard, car console or any cleaning cart or utility tray conveniently within reach for ready access for the purpose of cleaning windows.

13. Other objects and advantages of the present invention will become apparent from a careful reading of the detailed description provided herein, with appropriate reference to the accompanying drawings.
